(19) United States
(12) Patent Application Publication
(10) Pub. No.: US 2019/0219467 A1
(43) Pub. Date: Jul. 18, 2019

(54) High Pressure Gauge Structure

(71) Applicant: Chin Ray Industrial Ltd., Chiayi (TW)

(72) Inventor: Chiu-Sung Chou, Chiayi (TW)

(21) Appl. No.: 15/871,337

(22) Filed: Jan. 15, 2018

(51) Int. Cl. G01L 7/08

(52) U.S. Cl. CPC G01L 7/088; G01L 7/084; G01L 7/082

(57) ABSTRACT

A high pressure gauge contains: a frame, a holder, a film, a cylindrical support, an indicator set, a screwing element, a threaded column, and a push rod, wherein a seal ring is retained between the channel and the push rod. The central disc is defined between the film and a tab of the screwing element, when the push rod acts on the screwing element, the screwing element drives the central disc to push the film upward, and the central disc exerts a force on the film. The push rod has a C-shape retainer located in a part of the holder between the screwing element and the threaded column, when a pressure of the push rod disappears, the push rod is urged by the indicator set to move downward, and the C-shape retainer is biased against the threaded column so as to avoid a removal of the push rod.

### BACKGROUND OF THE INVENTION

### Field of the Invention

The present invention relates to a high pressure gauge structure which is capable of evenly exerting a force to push a film so as to measure an object stably, thus obtaining an arcuate measurement value.

### Description of the Prior Art

A conventional high pressure gauge structure is applied to measure a pressure value of an object so as to obtain pressure parameters of the object in production.

With reference to FIG. 1, the conventional high pressure gauge structure contains a frame 10 in a bow shape, a holder 20 in a cup shape and connected with a bottom of the frame 10, a film 30 defined between the frame 10 and the holder 20, a cylindrical support 40 abutting on the film 30, an indicator set 50 connected on the cylindrical support 40, a screwing element 60 screwed with a bottom of the cylindrical support 40, a threaded column 70 screwing with a bottom of the holder 20, and a push rod 80 inserting through the threaded column 70, wherein the push rod 80 abuts against the screwing element 60, the push rod 80 of the threaded column 70 passes through a channel. When a pressure pushes the push rod 80, the push rod 80 pushes the screwing element 60 to move upward so as to push the film 30 upward, and the indicator set 50 indicates the measurement value so as to obtain the pressure parameters of the object.

The film of the conventional high pressure gauge structure is pushed to achieve the measurement value, but it cannot exert force evenly as measure the object at a high pressure, thus causing inaccurate measurement. On the other hand, when the push rod is not pushed by the pressure, it slides in the channel randomly, thus losing the push rod easily.

The present invention has arisen to mitigate and/or obviate the afore-described disadvantages.

### SUMMARY OF THE INVENTION

The primary objective of the present invention is to provide a high pressure gauge structure in which a film abuts against a central disc evenly in a preferable force exerting area so as to obtain accuracy measurement.

Further objective of the present invention is to provide a high pressure gauge structure in which a push rod has a C-shape retainer configured to prevent a removal of the push rod.

Another objective of the present invention is to provide a high pressure gauge structure in which a contacting loop is defined between defined between a channel and a seal ring of a threaded column, thus enhancing a closing effect.

To obtain above-mentioned objectives, a high pressure gauge structure provided by the present invention contains: a frame in a bow shape, a holder in a cup shape, a film defined between the frame and the holder, a cylindrical support abutting on the film, an indicator set connected on the cylindrical support, a screwing element screwed with a bottom of the cylindrical support, a threaded column screwing with a bottom of the holder, and a push rod inserting through the threaded column, a front end of the push rod abutting against the screwing element, the push rod of the threaded column passing through a channel, and a seal ring being retained between the channel and a top rim of the push rod.

A central disc is defined between the film and a tab of the screwing element, when the push rod acts on the screwing element, the screwing element drives the central disc to push the film upward, and the central disc exerts a force on the film evenly.

The push rod has a C-shape retainer arranged on an extension thereof and located in a part of the holder between the screwing element and the threaded column, when a pressure of the push rod disappears, the push rod is urged by reaction force of the indicator set to move downward, and the C-shape retainer is biased against the threaded column so as to avoid a removal of the push rod.

In addition, a contacting loop is defined between the seal ring in the channel of the threaded column and the top rim of the push rod.

### BRIEF DESCRIPTION OF THE DRAWINGS

FIG. 1 is a cross sectional view showing the assembly of a conventional high pressure gauge structure.

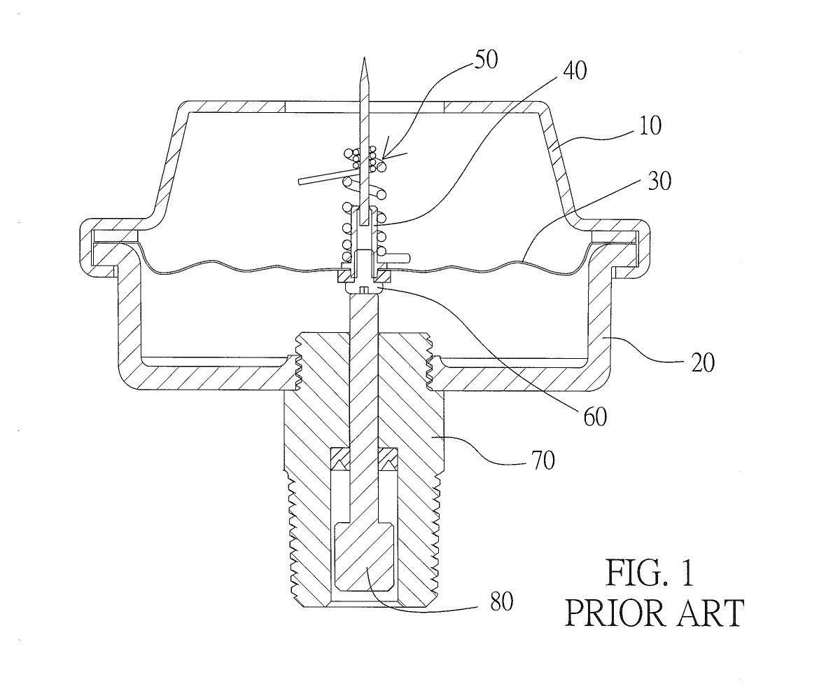

FIG. 2 is a cross sectional view showing the assembly of a high pressure gauge structure according to a preferred embodiment of the present invention.

FIG. 3 is a cross sectional view showing the operation of the high pressure gauge structure according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

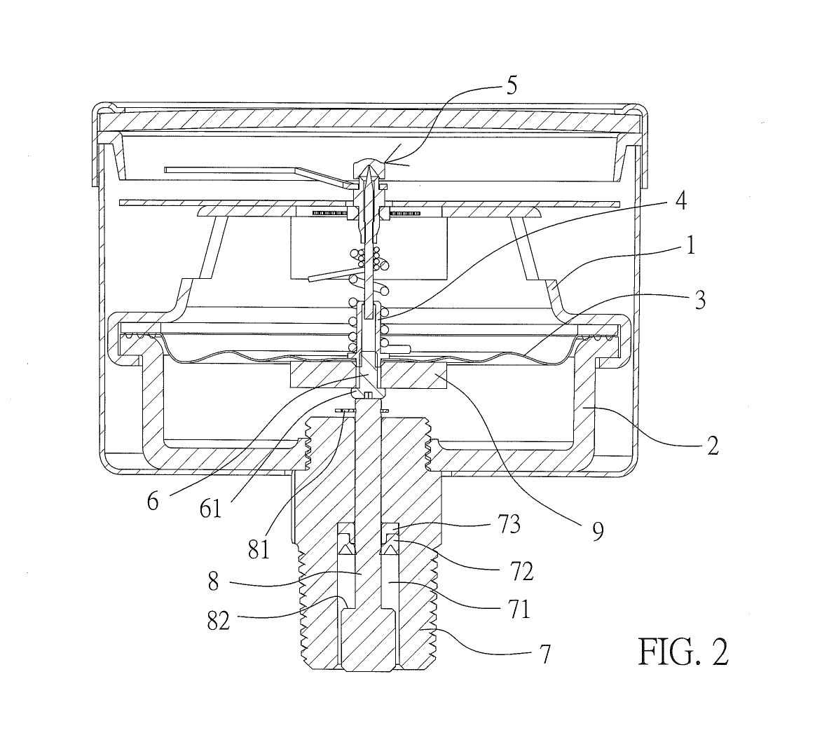

With reference to FIG. 2, a high pressure gauge structure in accordance with a preferred embodiment of the present invention comprises: a frame 1 in a bow shape, a holder 2 in a cup shape, a film 3 defined between the frame 1 and the holder 2, a cylindrical support 4 abutting on the film 3, an indicator set 5 connected on the cylindrical support 4, a screwing element 6 screwed with a bottom of the cylindrical support 4, a threaded column 7 screwing with a bottom of the holder 2, and a push rod 8 inserting through the threaded column 7, a front end of the push rod 8 abutting against the screwing element 6, the push rod 8 of the threaded column 7 passing through a channel 71, and a seal ring 72 being retained between the channel 71 and a top rim 81 of the push rod 8, characterized in that:
a central disc 9 is defined between the film 3 and a tab 61 of the screwing element 6, when the push rod 8 acts on the screwing element 6, the screwing element 6 drives the central disc 9 to push the film 3 upward, and the central disc 9 exerts a force on the film 3 evenly.

The push rod 8 has a C-shape retainer 81 arranged on an extension thereof and located in a part of the holder 2 between the screwing element 6 and the threaded column 7, when a pressure of the push rod 8 disappears, the push rod 8 moves randomly, and the C-shape retainer 81 is biased against the threaded column 7 so as to avoid a removal of the push rod 8.

A size and a material of the central disc 9 are adjustable based on the film 3.

A shape of the central disc 9 corresponds to the film 3.

A contacting loop 73 is defined between the seal ring 72 in the channel 71 of the threaded column 7 and the top rim 82 of the push rod 8.

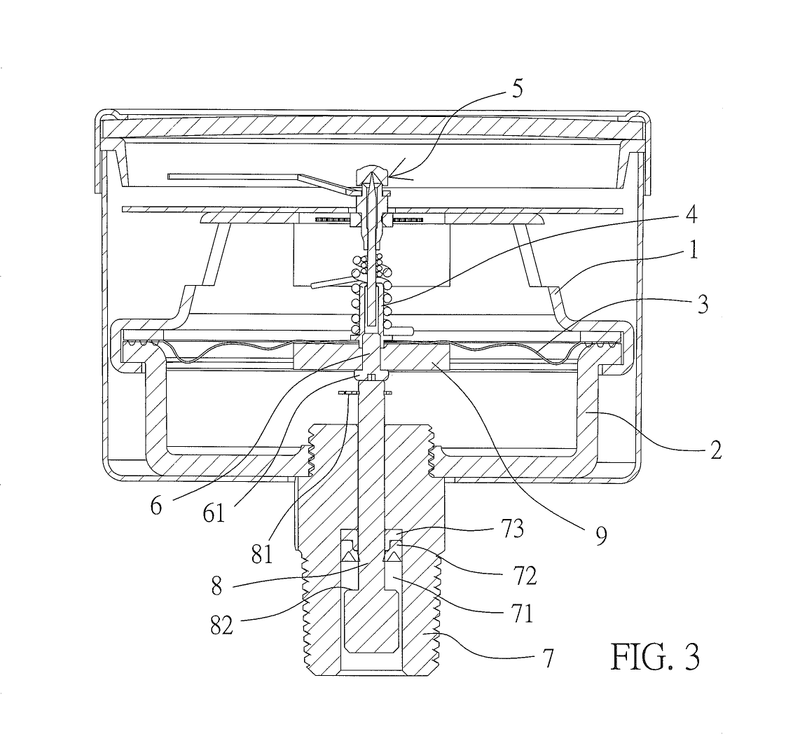

As shown in FIG. 3, in operation, an object is connected on the threaded column 7 so as to push the push rod 8 in the channel 71 of the threaded column 7 and to act on the screwing element 6, and the tab 61 of the screwing element 6 is pushed upward by the push rod 8 so as to drive the central disc 9 to push the film 3 upward. When the central disc 9 exerts force on the film 3, it acts on the indicator set 5 stably so as to obtain measurement parameters. The size of the central disc 9 is adjustable based on using requirements, and the shape of the central disc 9 corresponds to that of the film 3 (such as a wave shape). In a measuring process, the object acts on the push rod 8, the seal ring 72 is defined between the channel 71 of the threaded column 7 and the top rim 82 of the push rod 8 so as to avoid the object contacting with parts of the high pressure gauge structure to influence measurement accuracy, thus prolonging using life. Preferably, the contacting loop 73 is defined between the channel 71 and the seal ring 72 of the threaded column 7, thus enhancing closing effect.

After the measuring process, the threaded column 7 is removed from the object so that the push rod 8 is not pushed by a pressure and the screwing element 6 is not pushed, hence the indicator set 5 recovers its original state. When the push rod 8 is not pushed by the pressure or is hit in a taking process, the push rod 8 moves in the threaded column 7 randomly. After the push rod 8 is pushed outward at a distance, the C-shape retainer 81 in the holder 2 abuts against a top of the threaded column 7 so as to stop pushing the push rod 8 outward, thus preventing a loss of the push rod in the taking process and using inconvenience.

Accordingly, the central disc of the high pressure gauge structure of the present invention exerts the force on the film evenly so as to obtain accurate ad stable measurement. The C-shape retainer abuts against the top of the threaded column so as to avoid the loss of the push rod and the using inconvenience.

While various embodiments in accordance with the present invention have been shown and described, it is clear to those skilled in the art that further embodiments may be made without departing from the scope of the present invention.

What is claimed is:

1. A high pressure gauge comprising:
a frame in a bow shape, a holder in a cup shape, a film defined between the frame and the holder, a cylindrical support abutting on the film, an indicator set connected on the cylindrical support, a screwing element screwed with a bottom of the cylindrical support, a threaded column screwing with a bottom of the holder, and a push rod inserting through the threaded column, a front end of the push rod abutting against the screwing element, the push rod of the threaded column passing through a channel, and a seal ring being retained between the channel and a top rim of the push rod, characterized in that:
a central disc is defined between the film and a tab of the screwing element, when the push rod acts on the screwing element, the screwing element drives the central disc to push the film upward, and the central disc exerts a force on the film evenly; and
the push rod has a C-shape retainer arranged on an extension thereof and located in a part of the holder between the screwing element and the threaded column, when a pressure of the push rod disappears, the push rod is urged by reaction force of the indicator set to move downward, and the C-shape retainer is biased against the threaded column so as to avoid a removal of the push rod.

2. The high pressure gauge as claimed in claim 1, wherein a contacting loop is defined between the seal ring in the channel of the threaded column and the top rim of the push rod.

3. The high pressure gauge as claimed in claim 1, wherein a size and a material of the central disc are adjustable based on the film.

4. The high pressure gauge as claimed in claim 1, wherein a shape of the central disc corresponds to the film.
